(19) United States
(12) Patent Application Publication
(10) Pub. No.: US 2005/0146084 A1
(43) Pub. Date: Jul. 7, 2005

(54) Method for molding microstructures and nanostructures

(76) Inventors: David Simoneta, Locarno (CH); Alessandro A'Amore, Wohlen (CH)

Correspondence Address: BACHMAN & LAPOINTE, P.C., 900 CHAPEL STREET, SUITE 1201, NEW HAVEN, CT, 06510, US

(21) Appl. No.: 10/502,816

(22) PCT Filed: Nov. 11, 2002
(86) PCT No.: PCT/EP02/12567

(30) Foreign Application Priority Data
Jan. 25, 2002 (EP) 02001768.7

(51) Int. Cl. B29C 59/02; B29C 59/16

(52) U.S. Cl. 264/479; 264/488; 264/293

(57) ABSTRACT

A method for moulding microstructures and nanostructures on a layer that can be thermally structured by means of a structured mould using an electromagnetic radiation producing the required heat. A mechanically stable mould and a stable base are used. By absorbing a beam with high energy density, either the mould or the base is heated on the surface due to the low penetration depth of the beam. The generated heat is transmitted to the layer, and the softened layer is then structured by means of the mould. The layer that is used is as transmitting as possible and is penetrated by the beam before being heated. The heat required for moulding can be generated very rapidly by means of energy radiation absorption. The inventive method allows nanostructures and microstructures to be moulded on a substrate or be opened on a coated surface on structures in the nanometer range.

The invention relates to a method of shaping micro- and nanostructures on a layer, which is structurable by heat, by means of a structured moulding pattern, using electromagnetic radiation to generate the required heat, such as is known for example from JP-A-2001 158044 or U.S. Pat. No. 5,078,947.

The exact shaping of micro- and nanostructures is achieved nowadays with methods which have relatively high cycle times (hot stamping) or which work with initial materials which can make difficult the process control of important parameters (e.g. polymerisation and temperature in UV-casting). In faster processes such as injection moulding, the shaping of smaller structures is in certain cases (e.g. structures with a high aspect ratio) not possible in an optimum manner or only possible with cost- and time-intensive dynamic preliminary heating of the tool.

In many applications of micro- and nanotechnology, methods are required which simultaneously permit rapid cycle times, precise shaping and a local control of the heat supply to the location to be heated or to be structured. This is for example the case if different substrates are to be structured and connected together by the supply of heat without mutually impairing their individual functionality (microstructured components having functionalised surfaces, microchannels with biologically or chemically active substrates as well as diffractive surfaces, etc.). Rapidity and the quality of shaping are also the advantages of nanolithographic embossing methods by comparison with serial methods such as direct electron-beam lithography. In nanolithographic embossing methods, precise control of the thickness of the residual layer and rapid multiplication of the structured pattern at various locations of a coated substrate are advantageous.

The object underlying the present invention, therefore, is to propose a possible way in which rapid and exact shaping of micro- and nanostructures is possible, especially with short process times and local control of the heat supply.

This object is accomplished according to the invention by a method having the features of the main claim. Further advantageous embodiments can be taken from the subordinate claims.

According to the method, a mechanically stable moulding pattern and a stable layer carrier are used. The moulding pattern or the layer carrier are heated by absorption of a ray of high energy density only on the surface because the ray has a small depth of penetration, such that the generated heat is transmitted to the layer. Then the softened layer is structured by means of the moulding pattern, a layer being used which is as largely transmitting as possible for the ray and is penetrated by the ray prior to the absorption in the moulding pattern. Thus in the method, only indirect heating of the structurable layer takes place. This occurs either due to the heating of the layer carrier or due to the penetration of a heated moulding pattern. The energy density of the ray, which can be achieved for example with a high capacity diode laser in the infrared range, must be so high and the penetration depth of the surface must be so small that the substrate very quickly reaches the temperature and temperature distribution which is necessary for the shaping of the desired structures. Depending on the moulding pattern, this process is supported by a continuous or pulsating guidance of the beam. Here it is possible through a suitable optical system to move a fine punctiform or linear laser beam over the surface to be heated.

What is important here is that the heating is so short that substantial heat dissipation, which is a function of the heat conductivity of the substrate, and undesired heat distribution are avoided. Consequently the energy supply and the heating which depends on same must be selected in dependence on the heat conductivity. For setting the process parameters, therefore, first the heat conductivity must be determined and then the correspondingly suitable process duration and supply energy must be determined in order to obtain the desired results.

The method permits very short cycle times and simultaneously a very good shaping quality, the very low thermal inertia of the entire system and the local and concentrated dynamic heating making this possible.

The layer which consists of a material which is sufficiently transmitting for the radiation, for example polycarbonate or PMMA, can be connected to an absorbent layer by this same radiation source directly after the shaping of the structures, such as e.g. during laser welding, so that shaping and assembly can take place on the same device.

In the present case, it is not embossing alone which is understood under shaping. Due to the irradiation of semi-conductive materials, for example silicon, which have a very small penetration depth for the radiation, at the irradiated surface, besides heat, charge carriers can also be produced which induce electrohydrodynamic effects in a melt and in so doing can support the shaping.

By simple control/regulation of the radiation source, the heat supply can be determined which is optimal for the material, the type of structures to be shaped and the type of connections. The continuous or pulsating guidance of the beam through a mask or suitable optical system here supports the delimitation of the heated surface.

In material technology, especially coating technology and in powder technology, transmitting and absorbent materials are still being developed which can be used for the method. It is also possible to provide curved layer carriers and moulding patterns.

The invention is described in greater detail below with the aid of embodiments, in conjunction with the accompanying drawings. These represent:

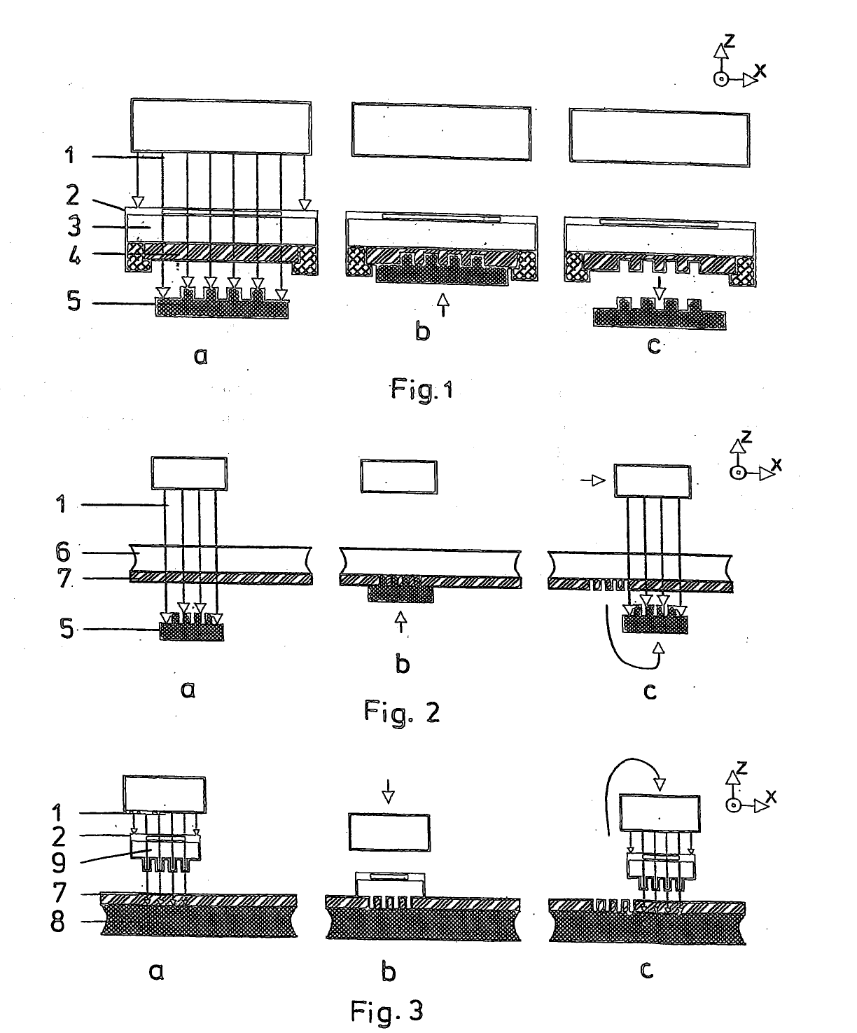

FIG. 1 the shaping of micro- and nanostructures on a substrate;

FIG. 2 the nanolithographic shaping on ray-permeable layer carriers and

FIG. 3 the nanolithographic shaping on ray-absorbent layer carriers.

According to FIG. 1a, a ray of heat 1 is guided through a ray-permeable plate 3, formed for example from quartz glass, and a ray-permeable substrate 4 pressed against this plate. Through a mask 2 or through a suitable optical system, the dimensions of the ray of energy can be adapted to the embossing pattern 5 located under same as the moulding pattern. The embossing pattern 5, formed for example from silicon or nickel phosphorous, is very rapidly heated up by the absorption of the heat ray on the surface as a result of the low penetration depth. Micro- or nanostructures on the embossing pattern 5 can then be shaped onto the substrate 4 (FIG. 1b). After the necessary cooling time, the shaped substrate 4 is removed from the embossing pattern 5 (FIG. 1c). In series with the shaping process, features can be welded onto the substrate 4 by the direct absorption of the heat ray. The substrate 4 represents in this method both the layer carrier and the structurable layer.

In the embodiment according to FIG. 2 it is shown that the generation of nanostructured resist masks is also possible by lithographic shaping according to the method. Here a ray-permeable plate 6 is coated with a suitable material, for example PMMA or polycarbonate. The energy ray 1 penetrates the plate 6 and the layer 7 and heats the nanostructured surface, lying underneath same, of the embossing pattern 5 (FIG. 2a). Thereafter structures can be shaped into the layer 7 (FIGS. 1b and 1c). By displacing the radiation source for the energy beam 1 and the embossing pattern 5 relative to the plate 6 and the layer 7, shapings can be repeated at various locations and thus structures in the nanometre range can be replicated on larger surfaces.

FIG. 3 shows a possible way of producing a resist mask for a ray-absorbent plate 8. For this purpose, this plate 8 is first coated with a suitable material 7 (FIG. 3a). The structured embossing pattern 9 is in this case ray-permeable and can have a mask 2 on the upper side. Through this mask, deliberate guidance of the ray and thus a locally defined heating-up of the ray-absorbent plate 8 can be achieved. The result of this is that the surface of the layer 7 can be melted locally independently of the dimension of the embossing pattern 9. This is very advantageous for shaping structures beside one another and thus being able to multiply the structures in the nanometre range on larger surfaces. This comes about, similarly to Fig. 2, due to displacement in the x-, y- and z-directions of the energy ray 1, the mask 2 and the embossing pattern 9 relative to the layer 7 and the plate 8 (FIGS. 3b and 3c). The spacing between the individual shaped portions can be very small in this variant. As the energy source for the generation of the high-energy density, a high-capacity diode laser can be used for example which emits in the infrared range.

In both variants of the nanolithographic shaping (FIGS. 2 and 3), the low thermal inertia of the system permits an effective control of the residual layer merely by purposeful guidance of the energy ray. The shaped resist mask can be used as a pattern for nanostructuring the substrate by etching or electroforming.

1. Method of shaping micro- and nanostructures on a layer, which is structurable by heat, by means of a structured moulding pattern (5, 9), using electromagnetic radiation to generate the required heat, wherein a mechanically stable moulding pattern (5, 9) and a stable layer carrier (4, 6, 8) are used, the moulding pattern or the layer carrier is heated by absorption of a ray (1) of high energy density, on the surface because the ray has a small depth of penetration, the generated heat is transmitted to the layer (4, 7), and subsequently the softened layer is structured by means of a moulding pattern, a layer being used which is as largely transmitting as possible for the ray and is penetrated by the ray prior to the heating process.

2. Method according to claim 1, characterized in that the moulding pattern (5, 9) or the layer carrier (4, 6, 8) is produced from silicon or nickel phosphorous.

3. Method according to claim 1, characterized in that the irradiated surface is defined by a mask (2).

4. Method according to claim 1, characterized in that a structured moulding pattern (5, 9) is brought into the vicinity of the layer (4, 7), is in contact therewith or is pressed against the layer, either the moulding pattern or the layer carriers being previously heated.

5. Method according to claim 1, characterized in that the radiation is transmitted additionally by the moulding pattern (9) or the layer carrier (4, 6) and is accordingly absorbed by the layer carrier (8) or the moulding pattern (5) respectively.

6. Method according to claim 1, characterized in that a linear beam of energy is moved at least once over the moulding pattern.

7. Method according to claim 1, characterized in that the irradiated surface is irradiated over the area by a suitable optical system.
